(19) United States
(12) Patent Application Publication
(10) Pub. No.: US 2014/0285111 A1
(43) Pub. Date: Sep. 25, 2014

(54) Lighting Control System and Lighting Control Method

(71) Applicant: Toshiba Lighting & Technology Corporation, Yokosuka-shi (JP)

(72) Inventor: Junko Takahashi, Yokosuka-shi (JP)

(73) Assignee: TOSHIBA LIGHTING & TECHNOLOGY CORPORATION, Yokosuka-shi (JP)

(21) Appl. No.: 14/013,388

(22) Filed: Aug. 29, 2013

(30) Foreign Application Priority Data
Mar. 25, 2013 (JP) 2013-062700

(51) Int. Cl. H05B 33/08

(52) U.S. Cl. CPC H05B 33/0845
USPC 315/294

(57) ABSTRACT

According to one embodiment, a lighting control system includes information on a corresponding relationship between each of a center area and a peripheral area and each of lighting fixtures which illuminates each of the one region and the peripheral region, in a gradation control region including the center area and the peripheral area. The CPU executes a gradation control in which an illumination range and illuminance of the gradation control region is changed by performing a dimming control of each of the lighting fixtures so that, in brightness of the gradation control region, brightnesses of the center area and the peripheral area are changed while causing the center area to be brighter than the peripheral area in proportion to a control input value which is input by a switch.

### CROSS-REFERENCE TO RELATED APPLICATION

This application is based upon and claims the benefit of priority from the Japanese Patent Application No. 2013-62700, filed on Mar. 25, 2013; the entire contents of which are incorporated herein by reference.

### FIELD

Embodiments described herein relate generally to a lighting control system and a lighting control method.

### BACKGROUND

In the related art, a lighting control system was widely used in order to control lighting in a building, or the like.

For example, a lighting system exists in which lighting is performed by installing a plurality of lighting fixtures on a ceiling with respect to an area to be illuminated such as an office, or the like. In a case of such a lighting system, a lighting control is performed by performing a simultaneous ON/OFF control of all of lighting fixtures in an office, or by performing an ON/OFF control of lighting fixtures in each designated area.

Usually, a lighting control is performed by performing an ON/OFF control of all of lighting fixtures in an office, or all of lighting fixtures in a designated area in this manner, or by performing a dimming control using an instructed dimming level; however, a method in which a part of lighting fixtures is subject to gradation lighting so as to meet a variety of requests in a place to be illuminated is also suggested.

For example, a lighting system which is capable of performing a gradation control in a lighting system which is configured like one LED lamp by aligning a lamp with a plurality of LEDs which are aligned in line in a jointless manner is suggested. All of LEDs in a gradation lighting range are driven with the same dimming level in the middle of an ON state or an OFF state, and LEDs out of the range of the gradation lighting are subject to an ON or OFF control.

However, in a gradation control in the suggestion, it is possible to set a gradation lighting range in which LEDs among a plurality of LEDs which are aligned in line are caused to emit light with middle brightness of an ON state, or an OFF state; however, it is not possible to change the gradation lighting range and illuminance of the range to be an optimal range and illuminance for a person who is in the range to be illuminated.

### BRIEF DESCRIPTION OF THE DRAWINGS

FIG. 1 is a configuration diagram of a lighting control system according to a first embodiment.

FIG. 2 is a diagram which illustrates switches for performing a gradation control according to the first embodiment.

FIG. 3 is a diagram which illustrates an example in which the switch according to the first embodiment is a slider.

FIG. 4 is a diagram which illustrates an example in which the switch according to the first embodiment is a knob.

FIG. 5 is a diagram which describes a gradation region according to the first embodiment as a range in which a gradation control is performed.

FIG. 6 is a diagram which illustrates a setting example of a gradation control region according to the first embodiment which is different from a setting method in FIG. 5.

FIG. 7 is a diagram which illustrates a setting example of a gradation control region according to the first embodiment which is different from the setting methods in FIGS. 5 and 6.

FIG. 8 is a diagram which illustrates an example of a gradation control target table according to the first embodiment in which corresponding information on an area and a lighting fixture is set.

FIG. 9 is a graph which illustrates a relationship between a control input value and a control output value according to the first embodiment.

FIG. 10 is a diagram which illustrates a state in which four lighting fixtures in a center area is subject to a dimming control in a control output range when the control input value is in a control input range according to the first embodiment.

FIG. 11 is a diagram which illustrates a state in which the four lighting fixtures of the center area are subject to dimming controls at the upper limit value of the control output range when the control input value reaches the upper limit value of the control input range according to the first embodiment.

FIG. 12 is a diagram which illustrates a state in which the four lighting fixtures of the center area are subject to dimming controls at the upper limit value when the control input value is in the control input range, and the twelve lighting fixtures of the peripheral area are subject to dimming controls in the control output range according to the first embodiment.

FIG. 13 is a diagram which illustrates a state in which the four lighting fixtures of the center area and the twelve lighting fixtures of the peripheral area are respectively subject to dimming controls at the upper limit value, when the control input value reaches the upper limit value of the control input range according to the first embodiment.

FIG. 14 is a diagram which illustrates a state in which the four lighting fixtures of the center area, and the twelve lighting fixtures of the peripheral areas are respectively subject to dimming controls at the upper limit value, and twenty lighting fixtures of the peripheral area are subject to dimming controls in a control output range, when the control input value is in a control input range according to the first embodiment.

FIG. 15 is a diagram which illustrates a state in which the four lighting fixtures of the center area, the twelve lighting fixtures of the peripheral area, and the twenty lighting fixtures of the peripheral area are respectively subject to dimming controls at respective upper limit values, when the control input value reaches the upper limit value of the control input range (that is, when control input value becomes 100 in FIG. 9) according to the first embodiment.

FIG. 16 is a flowchart which illustrates an example of a flow of a gradation control mode process according to the first embodiment.

FIG. 17 is a flowchart which illustrates an example of a flow of the gradation control mode process according to the first embodiment.

FIG. 18 is a configuration diagram of a lighting control system according to a second embodiment.

FIG. 19 is a diagram which describes a range in which a camera unit is provided, and a gradation control is performed according to the second embodiment.

FIG. 20 is a flowchart which illustrates an example of a flow of a gradation control mode process according to the second embodiment.

### DETAILED DESCRIPTION

In general a lighting control system according to one embodiment includes a corresponding information setting unit in which information on a corresponding relationship between each of one region and a peripheral region of the one region and each of lighting fixtures which illuminates each of the one region and the peripheral region is set in a gradation control region including the one region and the peripheral region of the one region; and a control unit which performs a gradation control in which an illumination range and illuminance of the gradation control region are changed by performing a dimming control of each of the lighting fixtures so that, in brightness of the gradation control region, brightness of the one region and the peripheral region are changed while causing the one region to be brighter than the peripheral region in proportion to a control input value which is input to a control input unit.

Hereinafter, embodiments will be described with reference to drawings.

### First Embodiment

### Configuration

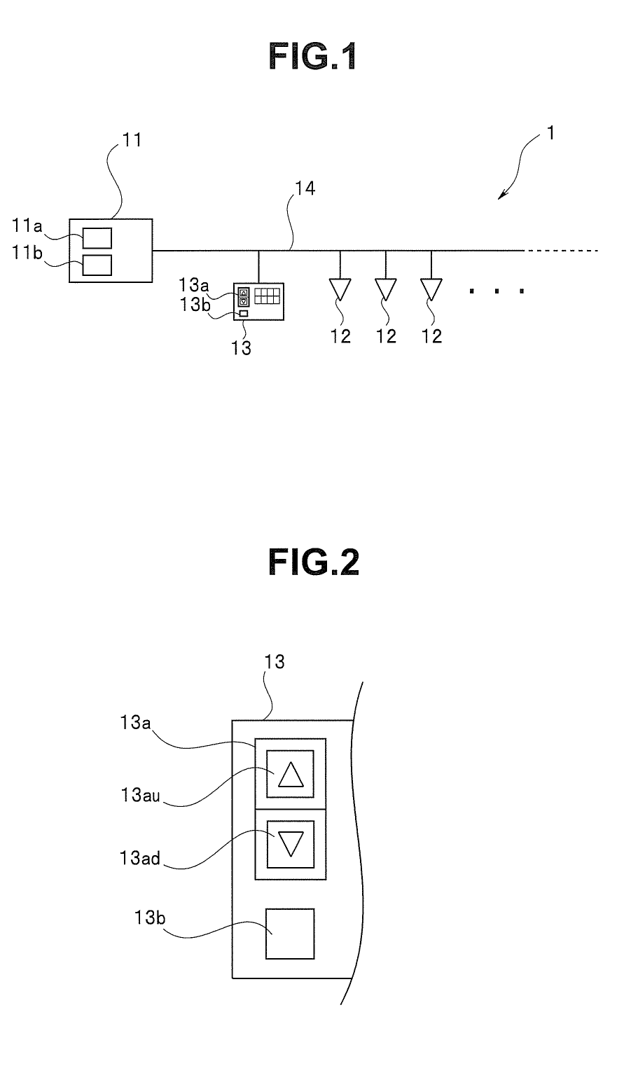

FIG. 1 is a configuration diagram of a lighting control system according to the embodiment. A lighting control system 1 is configured by including a control device 11 as a central device, a plurality of lighting fixtures 12, and a wall switch 13. The control device 11, the plurality of lighting fixtures 12, and the wall switch 13 are connected to each other through a signal transmission line 14.

Each lighting fixture 12 receives dimming data from the control device 11 through the signal transmission line 14. The wall switch 13 transmits various operation signals to the control device 11 through the signal transmission line 14.

The control device 11 includes a central processing unit (hereinafter, referred to as CPU) 11a, and a storage unit 11b including a ROM, a RAM, or the like. In the control device 11, the CPU 11a reads out a dimming control program and a gradation control program which are stored in the ROM, develops the programs in the RAM, and executes the programs, thereby executing each function of the lighting control system 1. Accordingly, the lighting control system 1 includes a gradation control mode in which a gradation control is executed, and other control modes (for example, normal control mode) than the gradation control mode.

The wall switch 13 is provided with gradation control switches 13a and 13b, in addition to a plurality of switches which switch an ON/OFF of lighting in each area.

Each lighting fixture 12 is a lighting system in which, for example, a light emitting diode (hereinafter, referred to as LED) as a light emitting unit is used, has a communication function, controls a light emitting amount of the light emitting unit based on dimming data which is received from the control device 11, and outputs illumination light.

FIG. 2 is a diagram which illustrates the gradation control switches 13a and 13b. The switch 13a which is provided in the wall switch 13 is a gradation changing switch for inputting a control input value CI for controlling a gradation. The switch 13a includes a switch 13au for increasing the control input value, and a switch 13ad for decreasing the control input value.

The switch 13a is configured so that, when the switch 13au is pressed, an operation signal for increasing the control input value CI are output while the switch 13au is pressed. In addition, the switch 13a is configured so that, when the switch 13ad is pressed, an operation signal for decreasing the control input value CI are output while the switch 13ad is pressed. Accordingly, a person who is in an office or the like is able to continuously change the control input value CI for the gradation control by operating the switch 13a.

In addition, the switch 13b is a gradation control instructing switch for giving an instruction on an ON/OFF of a gradation lighting control.

Operation signals of the switches 13a and 13b are transmitted to the control device 11 through the signal transmission line 14. When the switch 13b is operated and turned on, a gradation control is performed.

In addition, the switch 13a may be a slider, or a knob, not a two push button-shaped switch.

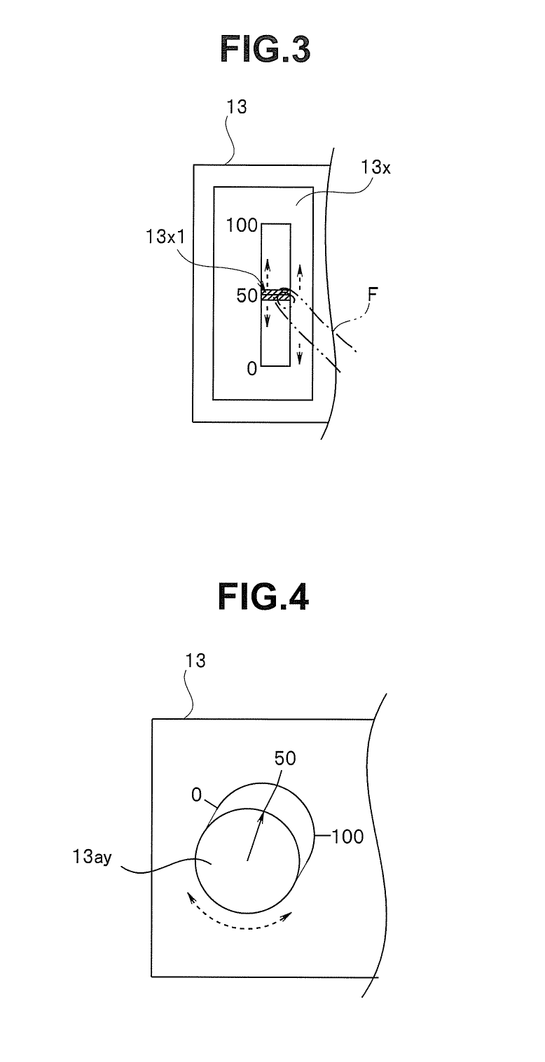

FIG. 3 is a diagram which illustrates an example in which the switch 13a is a slider. As illustrated in FIG. 3, a display 13x which is attached with a touch panel is provided in the wall switch 13, and a slider 13x1 as a moving unit which is movable in the straight line direction is displayed on a screen of the display 13x.

When a finger F moves in the vertical direction as denoted by a dotted line while touching the slider 13x1 which is displayed on the screen of the display 13x attached with the touch panel with the finger F, the slider 13x1 moves in the straight line direction on the screen, and it is possible to designate a control input value CI corresponding to a position to which the slider moved.

In addition, when a value of a control input value CI is displayed on the screen of the display 13x with a bar graph or the like, it is possible to designate the control input value CI, for example, by dragging a portion of the bar graph denoting the value of the control input value CI in the vertical direction using the finger F, without a display such as the slider 13x1. In such a case, the display of the slider 13x1 is not necessary, and the portion of the bar graph is the moving unit which is movable in the straight line direction.

Accordingly, the display 13x with the touch panel as an input unit which is illustrated in FIG. 3 is a control input unit which changes the control input value CI by moving the slider 13x1 as the moving unit which is movable in the straight line direction, or by changing a display of the bar graph.

FIG. 4 is a diagram which illustrates an example in which the switch 13a is a knob. As illustrated in FIG. 4, a knob 13ay is provided in the wall switch 13. An operator is able to designate a control input value CI corresponding to a position to which the cylindrical knob 13ay is moved by being rotated about an axis as denoted by a dotted line, by operating the knob 13ay by holding the knob using fingers.

Accordingly, the knob 13ay as an input unit which is illustrated in FIG. 4 is rotatable about an axis in a predetermined range, and is a control input unit which changes a control input value CI according to a rotating amount.

The switch 13a has a good operability since the switch can easily change an illumination range and illuminance of a gradation control when controlling gradation, even when the switch is in any of the shapes illustrated in FIGS. 2 to 4.

Here, the control input value CI which is set in the switch 13a is in a range of 0 to 100.

The control input value CI of the switch 13a for controlling gradation is transmitted to the control device 11, and the control device 11 performs a dimming control of a plurality of lighting fixtures 12 which illuminate a gradation control region so that a lighting fixture 12 in each area is dimmed with a control output value CO corresponding to a control input value CI.

Subsequently, a range in which a gradation control is performed will be described.

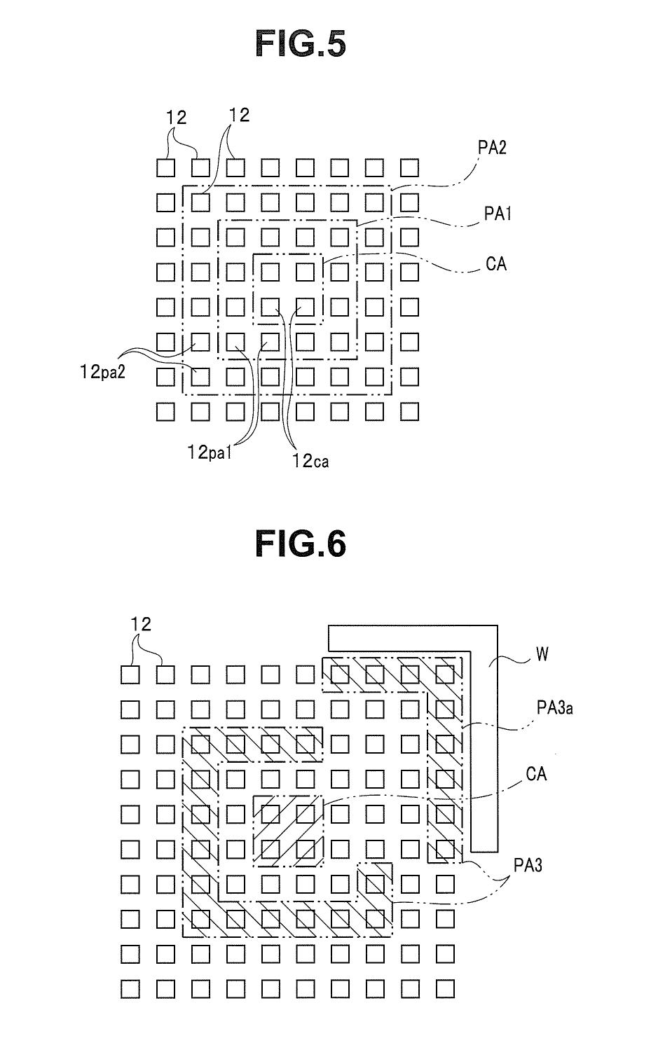

FIG. 5 is a diagram which describes a gradation control region as a range in which the gradation control is performed. FIG. 5 is a plan view which describes an illumination range which is illuminated by the plurality of lighting fixtures 12 which are provided on a ceiling.

In a case of a normal office, the plurality of lighting fixtures 12 are provided on a ceiling of a region to be illuminated in a building. For example, each lighting fixture 12 is subject to a dimming control by the control device 11 so that a room has predetermined brightness during daytime of weekdays. Alternatively, illumination in an office is performed when a lighting fixture in an area which is designated in the wall switch 13 is turned on.

However, there is a case in which illumination is necessary only in a specified area during nighttime, or the like. In addition, there is a case in which, for a working person, an illumination range which is necessary for work, and an optimal illuminance are different among individuals due to sensibility. For example, an illumination range and illuminance with which a person working alone at night does not feel a sense of uneasiness is different depending on a person.

Therefore, according to the embodiment, it is possible to set such that a desired area is adjusted to desired illuminance (that is, brightness) by setting a range of a gradation control (hereinafter, referred to as gradation control region) in advance, and by operating the switch 13a by a person in a room. In particular, the lighting control system 1 according to the embodiment is configured such that it is possible to widen an illumination range about a certain area, or to change illuminance.

A gradation control region is set when one center area CA, and one or more peripheral regions PA which are set in the periphery of the center area are set.

FIG. 5 illustrates an example in which the center area CA is set as an area which is illuminated by four lighting fixtures 12. For example, the center area CA is set as a center area of an area in which illumination is necessary at night.

In a case of FIG. 5, two peripheral areas PA are provided. A first peripheral area PA1 is adjacent to the center area CA, surrounds the center area CA, and is set to an area which will be illuminated by twelve lighting fixtures 12.

In addition, a second peripheral area PA2 is close to the first peripheral areas PA1, surrounds the first peripheral area PA1, and is set to an area which will be illuminated by twenty lighting fixtures 12. That is, the gradation control region includes the center area CA as the one region, the first peripheral area PA1 and the second peripheral area PA2 which are peripheral regions of the center area CA.

In addition, in a case of FIG. 5, the gradation control region is set such that the first peripheral areas PA1 are illuminated by the plurality of lighting fixtures 12 which are adjacent to the center area CA, and the second peripheral area PA2 is illuminated by the plurality of lighting fixtures 12 which are adjacent to the first peripheral areas PA1; however, setting of the gradation control region may be performed using other methods than the setting method.

FIG. 6 is a diagram which illustrates a setting example of the gradation control region which is different from the setting method in FIG. 5. In a case of FIG. 6, a peripheral area PA3 denoted by slant lines is an area which is the next area but one to the center area CA, not an area adjacent to the center area CA with respect to the center area CA which is denoted by slant lines, and a part thereof PA3a is set to an area which is further separated from the center area CA. The part PA3a is set at a position which is further separated from the center area CA since the part can also use reflection on a wall face of a wall W.

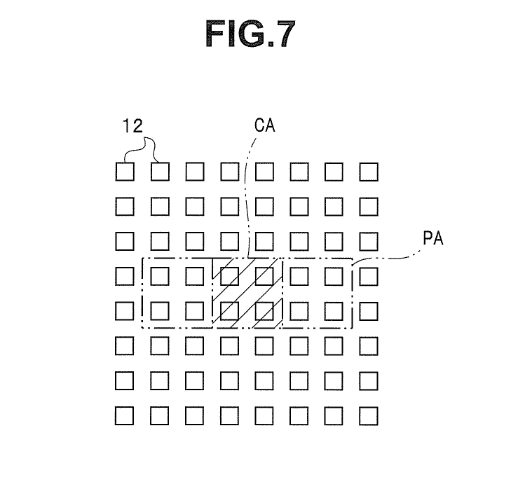

FIG. 7 is a diagram which illustrates a setting example of the gradation control region which is different from the setting method in FIGS. 5 and 6. In a case of FIG. 7, a peripheral area PA is not a peripheral area which is adjacent to the center area CA, and is an area which is adjacent to the center area CA in the horizontal direction. In addition, in a case of FIG. 7, as well, the peripheral area PA may be set to an area which is the next area but one to the center area in the horizontal direction, as illustrated in FIG. 6.

Returning to FIG. 5, here, as will be described later, a range from the center area CA to the second peripheral area PA2 is set to a gradation control region of illumination in which an illumination range and illuminance can be changed about the center area CA. That is, here, the gradation control region of illumination is a region inside the second peripheral area PA2 including the second peripheral area PA2.

In addition, corresponding information on an area and lighting fixtures in which one or more lighting fixtures 12 corresponding to each of three areas (that is, center area CA, first peripheral areas PA1, and second peripheral area PA2) are correlated with each area is set in the storage unit 11b. In FIG. 5, corresponding information on each lighting fixture 12 in the gradation control region and each area are stored in the storage unit 11b such that a lighting fixture 12ca is a lighting fixture which illuminates the center area CA, a lighting fixture 12pa1 is a lighting fixture which illuminates the first peripheral areas PA1, and a lighting fixture 12pa2 is a lighting fixture which illuminates the second peripheral area PA2.

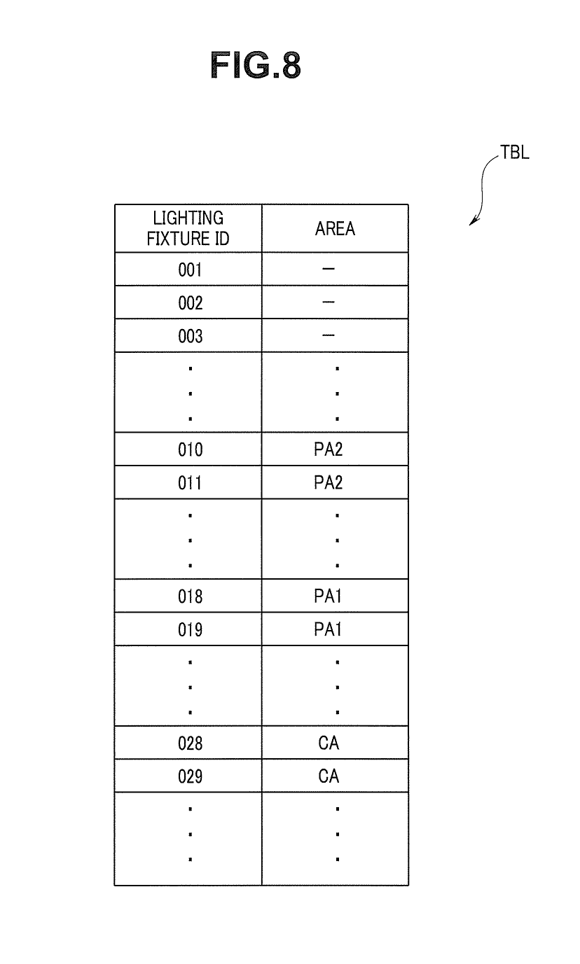

FIG. 8 is a diagram which illustrates an example of a gradation control target table TBL in which corresponding information on the area and the lighting fixture are set. As illustrated in FIG. 8, which area in the gradation control region will be illuminated by each lighting fixture as a control target of the gradation control is stored in the gradation control target table TBL which is stored in the storage unit 11b. FIG. 8 illustrates that, for example, a lighting fixture of which an ID is “010” is set as a lighting fixture which illuminates the peripheral area PA2.

Accordingly, the storage unit 11b configures a corresponding information setting unit in which information on a corresponding relationship between each region of the center area CA, and two peripheral areas PA1 and PA2 and each lighting fixture which illuminates each region in the gradation control region including the center area CA as one region, and two peripheral areas PA1 and PA2 as the peripheral regions of the center area CA is set.

In the gradation control, each lighting fixture 12 is subject to a dimming control by the control device 11 so that an ON/OFF control of the plurality of lighting fixtures 12 is performed so as to widen an illumination range about the center area CA, illuminance of the peripheral area PA1 is the illuminance of the center area CA or less, and illuminance of the peripheral area PA2 is the illuminance of the peripheral area PA1 or less.

Subsequently, a relationship between a control input value CI and a control output value CO in the gradation control will be described. In the gradation control, upper and lower limit values of a dimming control of each lighting fixture 12 in each area is set.

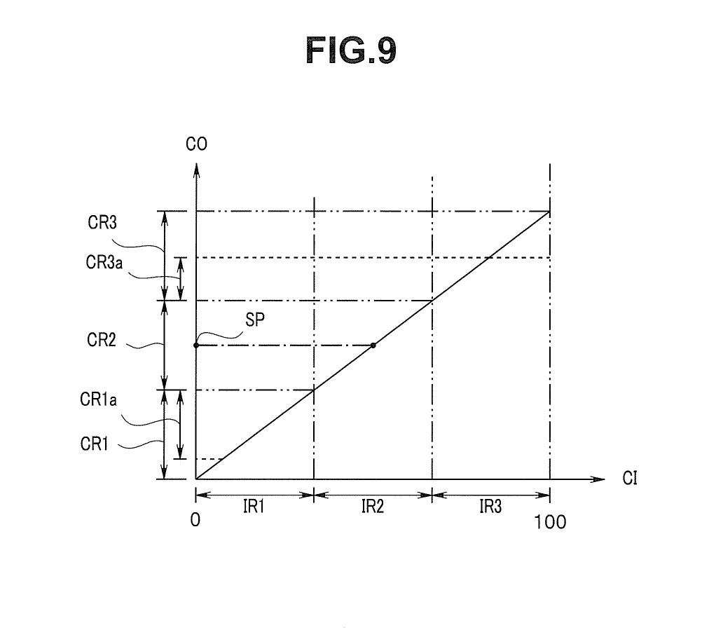

FIG. 9 is a graph which denotes a relationship between the control input value CI and the control output value CO. The horizontal axis denotes the control input value CI (here, values in range of 0 to 100) which is set in the switch 13a, and the vertical axis denotes the control output value CO in each area.

In a control output range CR1 corresponding to a control input range IR1 of the control input value CI, four lighting fixtures 12ca which illuminate the center area CA are subject to a dimming control between the lower limit value and the upper limit value which are set with respect to the control output range CR1. That is, in the control output range CR1, the four lighting fixtures 12ca which illuminate the center area CA are subject to a dimming control between the upper and lower limit values (for example, between 0 to 100%) which are set with respect to the control output range CR1.

In addition, in a control output range CR2 corresponding to a control input range IR2 of the control input value CI, twelve lighting fixtures 12pa1 which illuminate the peripheral area PA1 are subject to a dimming control between the lower limit value and the upper limit value which are set with respect to the control output range CR2, in a state in which four lighting fixtures 12ca which illuminate the center area CA maintain the brightness of an upper limit value (for example, 100%). That is, in the control output range CR2, the twelve lighting fixtures 12pa1 which illuminate the peripheral area PA1 are subject to a dimming control between the upper and lower limit values (for example, 0 to 100%) which are set with respect to the control output range CR2.

In addition, in a control output range CR3 corresponding to a control input range IR3 of the control input value CI, twenty lighting fixtures 12pa2 which illuminate the peripheral area PA2 are subject to a dimming control between a lower limit value and an upper limit value which are set with respect to the control output range CR3, in a state in which the four lighting fixtures 12ca which illuminate the center area CA, and the twelve lighting fixtures 12pa1 which illuminate the peripheral area PA1 maintain the brightness of each upper limit value (for example, 100%). That is, in the control output range CR3, the twenty lighting fixtures 12pa2 which illuminate the peripheral area PA2 are subject to a dimming control between the upper and lower limit values (for example, 0 to 100%) which are set with respect to the control output range CR3.

For example, when the switch 13a is operated, and the control input value CI is gradually changed from 0 to 100, the center area CA becomes gradually bright from brightness of the lower limit value (for example, 0%) of the control output range CR1. Subsequently, when the center area CA reaches the upper limit value (for example, 100%) of the control output range CR1, the peripheral area PA1 becomes gradually bright from the brightness of the lower limit value (for example, 0%) of the control output range CR2 while maintaining the brightness of the center area CA of the upper limit value.

Subsequently, when the peripheral area PA1 reaches the upper limit value (for example, 100%) of the control output range CR2, the peripheral area PA2 becomes gradually bright from the brightness of the lower limit value (for example, 0%) of the control output range CR3 while maintaining the brightness of the peripheral area PA1 of the upper limit value. When the control input value CI reaches 100, the peripheral area PA2 becomes brightness of the upper limit value (for example, 100%) of the control output range CR3.

In FIG. 9, when the control input value CI which is set by the switch 13a is in the range of the control input range IR1, the center area CA has the brightness between the lower limit value and the upper limit value of the control output range CR1. When the control input value CI increases from the lower limit value to the upper limit value of the control input range IR1, the control device 11 performs a dimming control of the four lighting fixtures 12ca in the center area CA according to the control input value CI so that the brightness of the center area CA is monotonically increased.

When the control input value CI which is set by the switch 13a moves from the control input range IR1 to the control input range IR2, the peripheral area PA1 has the brightness between the lower limit value and the upper limit value of the control output range CR2 while maintaining the brightness of the center area CA at the upper limit value (for example, 100%). When the control input value CI increases from the lower limit value to the upper limit value of the control input range IR2, the control device 11 performs a dimming control of the twelve lighting fixtures 12pa1 of the peripheral area PA1 according to the control input value CI so that the brightness of the peripheral area PA1 is monotonically increased.

When the control input value CI which is set by the switch 13a moves from the control input range IR2 to the control input range IR3, the peripheral area PA2 has brightness between the lower limit value and the upper limit value of the control output range CR3 while maintaining the respective brightness of the center area CA and the peripheral area PA1 at the upper limit value (for example, 100%). When the control input value CI increases from the lower limit value to the upper limit value of the control input range IR3, the control device 11 performs a dimming control of the twenty lighting fixtures 12pa2 of the peripheral area PA2 according to the control input value CI so that the brightness of the peripheral area PA2 is monotonically increased.

In addition, when the control input value CI which is set by the switch 13a becomes 100, the brightness of the center area CA, and the peripheral areas PA1 and PA2 become the brightness in which the four lighting fixtures 12ca of the center area CA, the twelve lighting fixtures 12pa1 of the peripheral area PA1, and the twenty lighting fixtures 12pa2 of the peripheral area PA2 correspond to a state of being maintained at the respective upper limit value (100%).

When the switch 13a is operated in the reverse direction, and the control input value CI is gradually changed from 100 to 0, the control device 11 performs a dimming control of the twenty lighting fixtures 12pa2 of the peripheral area PA2 according to the control input value CI so that the brightness of the peripheral area PA2 is monotonically decreased.

When the control input value CI which is set by the switch 13a moves from the control input range IR3 to the control input range IR2, the peripheral area PA1 has the brightness between the upper limit value and the lower limit value of the control output range CR2 in a state in which the twenty lighting fixtures of the peripheral area PA2 is maintained at the lower limit value of the control output range CR3 (for example, turned off state if lower limit value is 0%). When the control input value CI is decreased from the upper limit value to the lower limit value of the control input range IR2, the control device 11 performs a dimming control of the twelve lighting fixtures 12pa1 of the peripheral area PA1 according to the control input value CI so that the brightness of the peripheral area PA1 is monotonically decreased.

When the control input value CI which is set by the switch 13a moves from the control input range IR2 to the control input range IR1, the center area CA has the brightness between the upper limit value and the lower limit value of the control output range CR1 in a state in which the twelve lighting fixtures 12pa1 of the peripheral area PA1 is maintained at the lower limit value of the control output range CR2 (for example, turned off state if lower limit value is 0%). When the control input value CI is decreased from the upper limit value to the lower limit value of the control input range IR1, the control device 11 performs a dimming control of the four lighting fixtures 12ca of the center area CA according to the control input value CI so that the brightness of the center area CA is monotonically decreased.

In addition, when the control input value CI which is set by the switch 13a becomes 0, the brightness of the center area CA becomes the brightness corresponding to a state in which the four lighting fixtures 12ca of the center area CA is maintained at the lower limit value of the control output range CR1 (for example, turned off state if lower limit value is 0%).

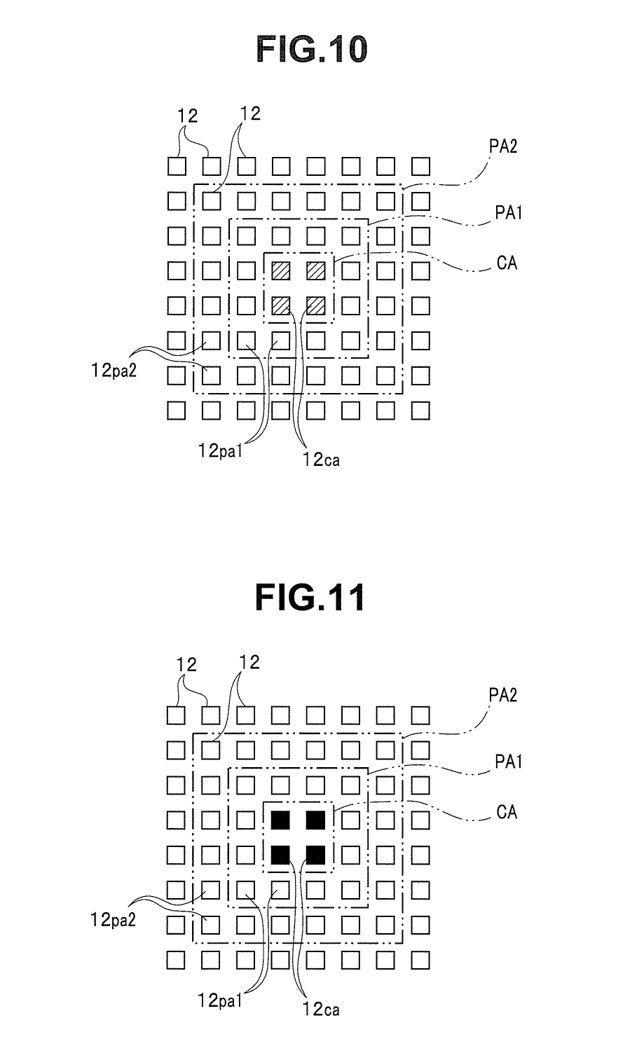

FIG. 10 is a diagram which illustrates a state in which, when the control input value CI is in the control input range IR1, the four lighting fixtures 12ca of the center area CA are subject to a dimming control in the control output range CR1. As denoted by slant lines, the four lighting fixtures 12ca are subject to a dimming control between the upper and lower limit values of the control output range CR1.

FIG. 11 is a diagram which illustrates a state in which, when the control input value CI reaches the upper limit value of the control input range IR1, the four lighting fixtures 12ca of the center area CA are subject to a dimming control at the upper limit value of the control output range CR1. As are painted out in black, the four lighting fixtures 12ca are subject to a dimming control at the upper limit value.

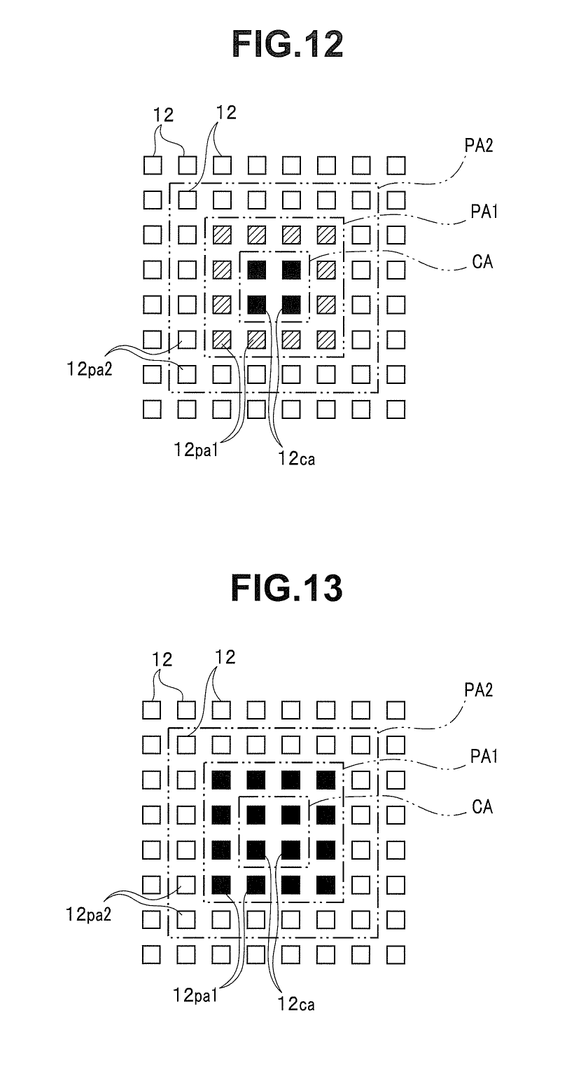

FIG. 12 is a diagram which illustrates a state in which, when the control input value CI is in the control input range IR2, the four lighting fixtures 12ca of the center area CA are subject to a dimming control at the upper limit value, and the twelve lighting fixtures 12pa1 of the peripheral area PA1 are subject to a dimming control in the control output range CR2. As are painted out in black, the four lighting fixtures 12ca are subject to a dimming control at the upper limit value of the control output range CR1, and as denoted by slant lines, the twelve lighting fixtures 12pa1 are subject to a dimming control between the upper and lower limit values of the control output range CR2.

That is, when being changed from the state in FIG. 11 to the state in FIG. 12, if a control output value for controlling the brightness of the center area CA as the one region reaches the upper limit value of the set control output range CR1, a CPU 11a as a control unit performs a dimming control of each lighting fixture 12 so that the brightness of the peripheral area PA1 is changed after setting the control output value for controlling the brightness of the peripheral area PA1 as the peripheral region to the lower limit value of the control output range CR2.

In addition, when being reversely changed from the state in FIG. 12 to the state in FIG. 10 via the state in FIG. 11, if the control output value for controlling the brightness of the peripheral area PA1 as the peripheral region reaches the lower limit value of the set control output range CR2, the CPU 11a as the control unit performs a dimming control of each lighting fixture 12 so that the brightness of the center area CA is changed after setting the control output value for controlling the brightness of the center area CA as the one region to the upper limit value of the control output range CR1.

FIG. 13 is a diagram which illustrates a state in which the four lighting fixtures 12ca of the center area CA, and the twelve lighting fixtures 12pa1 of the peripheral area PA1 are respectively subject to a dimming control at the upper limit value when the control input value CI reaches the upper limit value of the control input range IR2. As are painted out in black, the four lighting fixtures 12ca and the twelve lighting fixtures 12pa1 are subject to a dimming control at the respective upper limit values.

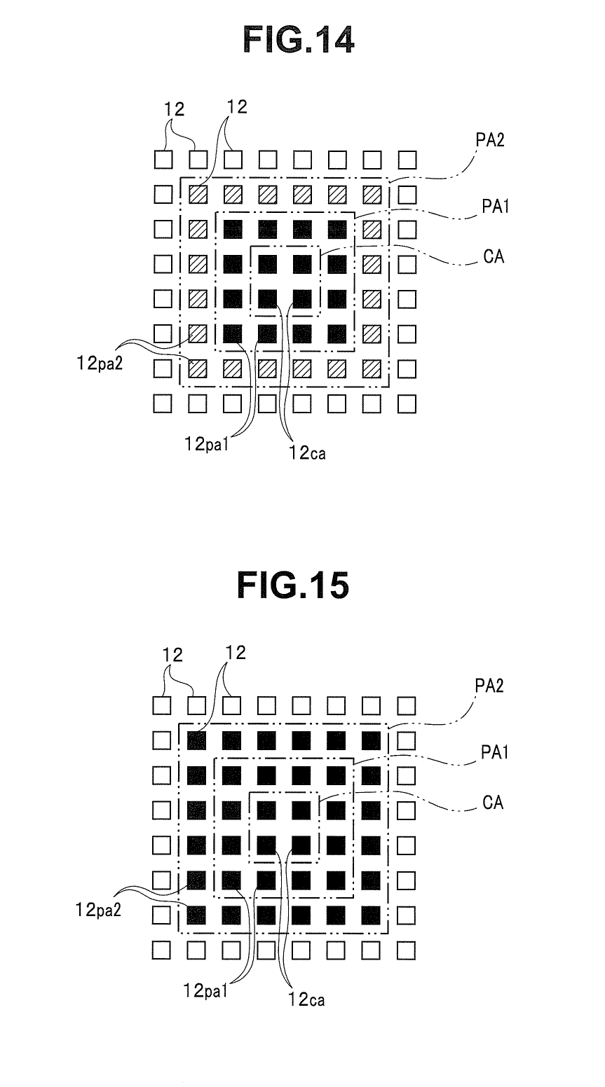

FIG. 14 is a diagram which illustrates a state in which, when the control input value CI is in the control input range IR3, the four lighting fixtures 12ca of the center area CA, and the twelve lighting fixtures 12pa1 of the peripheral area PA1 are respectively subject to dimming controls at the respective upper limit values, and the twenty lighting fixtures 12pa2 of the peripheral area PA2 are subject to a dimming control in the control output range CR3. As are denoted by being painted out in black, the four lighting fixtures 12ca and the twelve lighting fixtures 12pa1 are subject to dimming controls at the respective upper limit values, and as are denoted by slant lines, the twenty lighting fixtures 12pa2 are subject to the dimming control between the upper and lower limit values of the control output range CR3.

FIG. 15 is a diagram which illustrates a state in which, when the control input value CI reaches the upper limit value of the control input range IR3 (that is, when control input value CI becomes 100 in FIG. 9), the four lighting fixtures 12ca of the center area CA, the twelve lighting fixtures 12pa1 of the peripheral area PA1, and the twenty lighting fixtures 21pa2 of the peripheral area PA2 are respectively subject to dimming controls at respective upper limit values. As the four lighting fixtures 12ca, the twelve lighting fixtures 12pa1, and the twenty lighting fixtures 12pa2 are denoted by being painted out in black, the lighting fixtures 12ca, the lighting fixtures 12pa1, and the lighting fixtures 12pa2 are subject to dimming controls at the respective upper limit values.

As described above, in the brightness of the gradation control region, each lighting fixture is subject to a dimming control so that the brightness in the center area CA and the peripheral areas are changed while making the brightness in the center area CA as the one region brighter than those in the peripheral areas PA1 and PA2 as the peripheral regions in proportional to the control input value which is input to the switch 13a as the control input unit, the illumination range and the illuminance in the gradation control region are changed. In addition, in the above described example, in the brightness of the plurality of lighting fixtures 12 which illuminate each area, the upper and lower limit values in each control output range are set between 0% to 100%; however, the upper limit value may not be 100%, and the lower limit value may not be 0%, either.

For example, in FIG. 9, as denoted by dotted lines, when the lower limit value in the control output range CR1 of the four lighting fixtures 12ca of the center area CA is set to a value which is not 0%, there is a merit of obtaining the brightness of a minimum level even when the control input value CI for controlling the gradation control becomes 0. In this case, a control output range of the four lighting fixtures 12ca which illuminate the center area CA becomes a range CR1a in FIG. 9.

That is, the control input value for controlling the brightness of the center area CA as the one region has a lower limit value, and the CPU 11a as the control unit does not make the control output value for controlling the brightness of the center area CA equal to or lower than the lower limit value.

In addition, in FIG. 9, as denoted by a dotted line, when it is possible to set an upper limit value of the control output range CR3 of the twenty lighting fixtures 12pa2 of the peripheral area PA2 to be changeable to a value which is not 100%, there is a merit of achieving an object such as desired power saving. In this case, a control output range of the twenty lighting fixtures 12pa2 of the peripheral area PA2 is set to a range CR3a in FIG. 9.

That is, the control output value for controlling the brightness of the peripheral area PA2 as the peripheral region has an upper limit value, and the CPU 11a as the control unit does not make the control output value for controlling the brightness of the peripheral area PA2 equal to or higher than the upper limit value.

### Operation

Subsequently, operations of the lighting control system 1 with the above described configuration will be described.

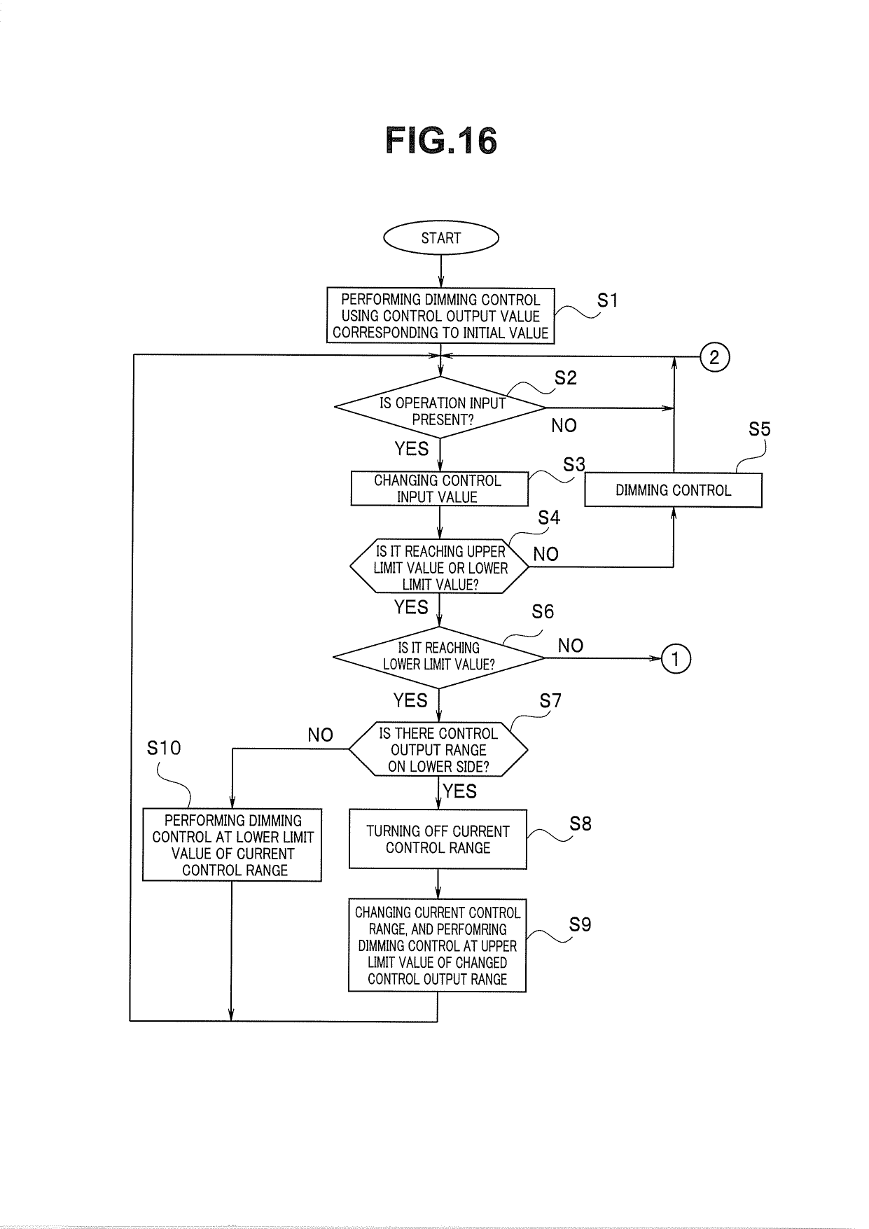

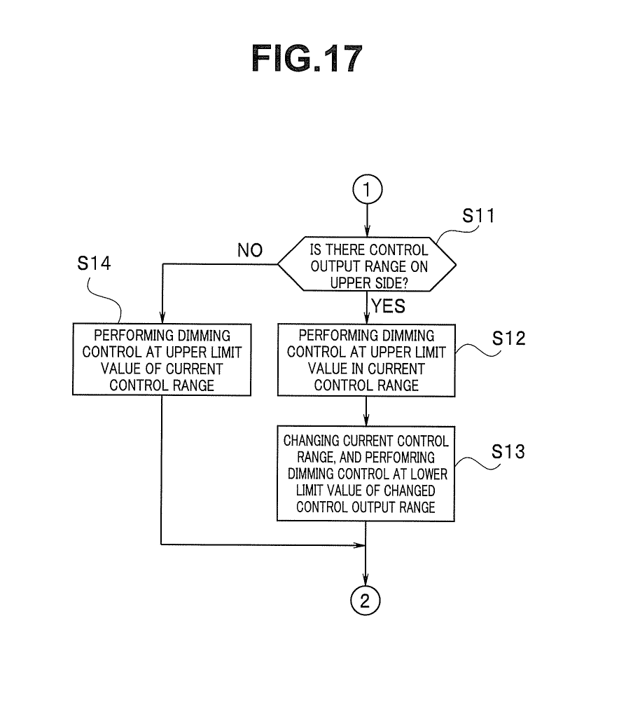

When a predetermined trigger occurs in the control device 11, for example, when detecting pressing of the switch 13b of the wall switch 13, the lighting control system 1 becomes a gradation control mode, and the CPU 11a executes a gradation control program in FIGS. 16 and 17. FIGS. 16 and 17 are flowcharts which illustrate examples of flows of gradation control mode processing.

When the CPU 11a of the control device 11 executes the gradation control mode program which is stored in the ROM by reading out the program, operations below are executed.

When the switch 13b is pressed, first, the CPU 11a performs a dimming control of each lighting fixture 12 in a gradation control range with an initial value of the control output value CO which is preset (S1).

For example, the CPU 11a performs a dimming control of each lighting fixture 12 with an initial value SP of the control output value CO which is denoted in FIG. 9. In this case, since the initial value SP is in the control output range CR2, it becomes a dimming state which is illustrated in FIG. 12.

In addition, here, executing of the gradation control program is started using the pressing of the switch 13b as a trigger; however, the gradation control program may be executed using a time which is set in a time schedule as a trigger, using a clock function included in the control device 11.

In such a case, each lighting fixture 12 may be subject to a dimming control so that a dimming state of each lighting fixture before executing the gradation control program is gradually changed to a dimming state corresponding to the initial value SP.

For example, when it is assumed that a control mode is set to a gradation control mode at 9 pm by the time schedule, and executing of the gradation control program is automatically started, since a dimming state due to a normal control mode up to the point becomes a dimming state corresponding to the initial value SP by being gradually changed, there is no case in which a person in a room is frightened due to a sudden change in illumination.

That is, when being moved to the gradation control mode from a normal control mode as another control mode, the CPU 11a performs a dimming control of each lighting fixture 12 so that a dimming state before moving is gradually changed to an initial state of the preset gradation control.

After S1, whether or not there is an operation input to the switch 13a of the wall switch 13 is determined (S2). When there is no operation input (NO in S2), none of the processing is performed.

When there is an operation input (YES in S2), the CPU 11a changes the control input value CI according to the operation input (S3).

The CPU 11a determines whether or not the control output value CO corresponding to the changed control input value CI reaches an upper limit value, or a lower limit value in a current control range (S4).

For example, when the initial value SP is in the control output range CR2, the current control range is the control output range CR2. In this case, in S4, whether the control output value CO corresponding to the changed control input value CI reaches the upper limit value of the control output range CR2, or reaches the lower limit value of the control output range CR2 is determined.

When the changed control output value CO does not reach the upper limit value, or the lower limit value in the current control range (NO in S4), the CPU 11a performs a dimming control of each lighting fixture 12 according to the changed control output value CO (S5).

When the changed control output value CO reaches the upper limit value, or the lower limit value in the current control range (YES in S4), the CPU 11a determines whether or not the changed control output value CO reaches the lower limit value in the current control range (S6).

When the changed control output value CO reaches the lower limit value in the current control range (YES in S6), the CPU 11a determines whether or not there is a control output range on a lower side of the current control range (S7).

When there is a control output range on a lower side of the current control range (YES in S7), the CPU 11a turns off each lighting fixture 12 in the current control range which is subject to a dimming control according to the control output value CO (S8), changes the current control range to a control output range on the lower side of the current control range, sets the control output value CO to an upper limit value in the changed control output range, and performs a dimming control (S9). In S8, since each lighting fixture 12 in the current control range is set to be turned off when the control output value CO reaches the lower limit value, at time of increasing and decreasing in the control output value CO, hysteresis occurs when the lower limit value is not 0.

For example, when it is assumed that the control output value CO reaches the lower limit value of the control output range CR2 when the current control range is the control output range CR2, since the control output range CR1 is present on the lower side of the current control range, the CPU 11a turns off the twelve lighting fixtures 12pa1 of the peripheral area PA1 (S8), and performs a dimming control of the four lighting fixtures 12ca of the center area CA at the upper limit value of the control output range CR1 (S9).

After S9, the process returns to S2, and the presence or absence of an operation input is determined (S2), and when there is an operation input, and the control output value CO is further decreased (S3), the lighting fixture 12 is subject to a dimming control corresponding to the decreased control output value CO (S5).

As described above, when the control output value CO for controlling the brightness of the peripheral area PA1 as the peripheral region reaches the set lower limit value of the control output range CR2, the CPU 11a as the control unit performs a dimming control of each lighting fixture 12 so that the brightness of the center area CA is changed after setting the control output value CO for controlling the brightness of the center area CA as the one region to the upper limit value of the control output range CR1.

In addition, when there is no control output range on the lower side (NO in S7), the CPU 11a performs a dimming control of the lighting fixture 12 at the lower limit value of the current control range (S10), and the process returns to S2.

In addition, when the changed control output value CO does not reach the lower limit value of the current control range (NO in S6), the CPU 11a determines whether or not there is a control output range on an upper side of the current control range (S11).

When there is a control output range on the upper side of the current control range (YES in S7), the CPU 11a performs a dimming control of the lighting fixture 12 which was subject to a dimming control according to the control output value CO at the upper limit value of the current control range (S12), changes the current control range to a control output range on the upper side of the current control range, and performs a dimming control by setting the control output value CO to the lower limit value of the changed control output range (S13).

For example, when being reached the upper limit value in a case in which the current control range is the control output range CR1, since the control output range CR2 is present on the upper side of the current control range, the CPU 11a performs a dimming control of the four lighting fixtures 12ca of the center area CA at the upper limit value of the control output range CR1 (S12), and performs a dimming control of the twelve lighting fixtures 12pa1 of the peripheral area PA1 at the lower limit value of the control output range CR2 (S13).

After S13, the process returns to S2, the presence or absence of an operation input is determined (S2), and when there is an operation input, and the control output value CO is further decreased (S3), the lighting fixture 12 is subject to a dimming control according to the decreased control output value CO (S5).

As described above, when the control output value for controlling the brightness of the center area CA as the one region reaches the upper limit value of the set control output range CR1, the CPU 11a as the control unit performs a dimming control of each lighting fixture 12 so that the brightness of the peripheral area PA1 is changed after setting the control output value for controlling the brightness of the peripheral area PA1 as the peripheral region to the lower limit value of the control output range CR2.

In addition, when there is no control output range on the upper side (NO in S11), the CPU 11a performs a dimming control of the lighting fixture 12 at the upper limit value in the current control range (S14), and the process returns to S2.

As described above, the CPU 11a as the control unit performs a gradation control of changing an illumination range and illuminance in the gradation control region by performing a dimming control of each lighting fixture 12 so that the brightness of the center area CA, and the peripheral areas PA1 and PA2 are changed while making the center area CA as the one region brighter than the peripheral areas PA1 and PA2, in the brightness of the gradation control region, in proportion to the control input value which is input to the switch 13a as a control input unit.

In the related art, when a person works in an office alone at night, there is a case in which all of the lighting fixtures in the office are turned on, or only a part of lighting fixtures is turned on. Such lighting method of a lighting fixture is not preferable from a viewpoint of energy saving. In addition, when the lighting fixture is turned on so as to spotlight only an area of a desk of the person, since only a very narrow range is illuminated while the surroundings are dark, there is also a case in which it is not easy to see surroundings, and the person may feel uneasy.

In contrast to this, according to the lighting control system in the above described embodiment, it is possible to make the center area brightest, to easily change an illumination range of the gradation control region, and to easily change illuminance in the range. Accordingly, when a person works alone in an office at night, it is possible to make only a range in which the person does not feel uneasy be illuminated, and to illuminate the range with the brightness with which the person does not feel uneasy.

Accordingly, according to the above described embodiment, it is possible to realize a lighting control system and a lighting control method in which it is possible to change an illumination range and illuminance in a gradation control so that the illumination range and illuminance become optimal for a person in the illumination range.

### Second Embodiment

According to the above described first embodiment, the illumination range in which a gradation control is performed by setting the center area CA as the center is preset and fixed; however, in a second embodiment, an illumination range and illuminance of a gradation control are set according to the number of detected persons.

### Configuration

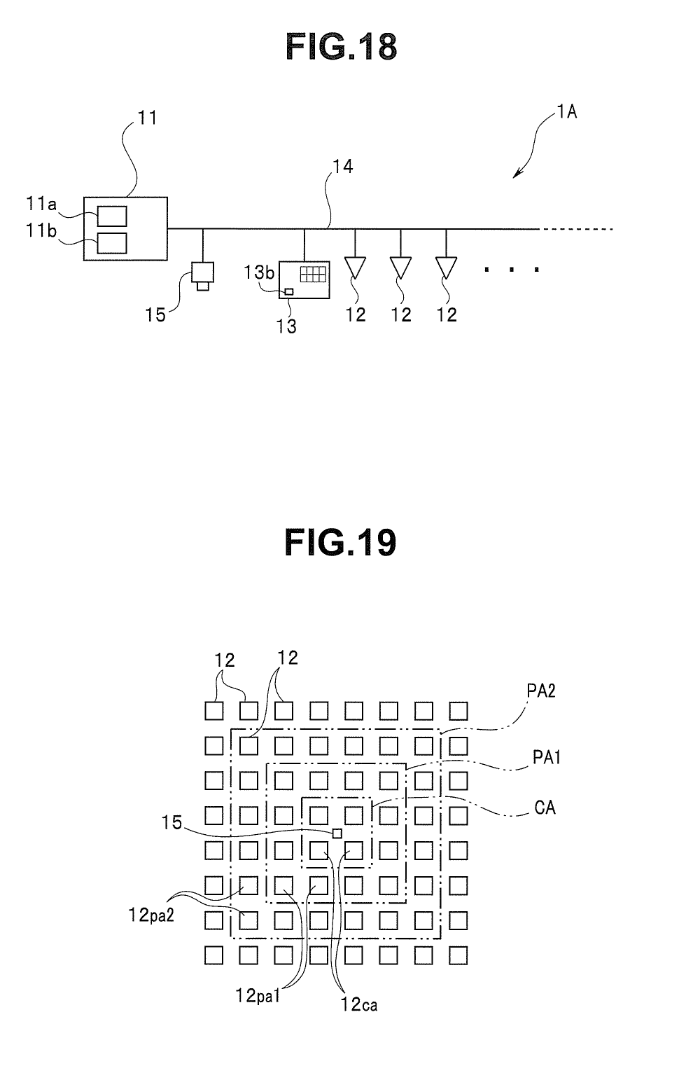

FIG. 18 is a configuration diagram of a lighting control system 1A according to the embodiment. The lighting control system 1A has approximately the same configuration as the lighting control system 1 according to the first embodiment. Accordingly, the same constituent elements are given the same reference numerals, descriptions thereof are omitted, and differences will be described.

The lighting control system 1A includes a camera unit 15 as an area sensor. The camera unit 15 is connected to a control device 11 through a signal transmission line 14. The camera unit 15 is installed in a building so as to image a gradation control region.

FIG. 19 is a diagram which describes a range in which the camera unit 15 is installed, and a gradation control is performed. FIG. 19 is a plan view which describes an illumination range which is illuminated by a plurality of lighting fixtures 12 which are provided on a ceiling, and an installation position of the camera unit 15 which is similarly provided on the ceiling.

The camera unit 15 has an area sensor such as a CMOS sensor, or a CCD sensor, and an object optical system, and is installed so as to image a region including the gradation control region. The camera unit 15 includes an image processing unit which analyzes imaged image data. The image processing unit can determine the presence or absence of a person, and the number of persons in an image from the obtained image data, for example, using a program for determining the number of persons. In addition, the camera unit 15 transmits the presence or absence of a person and the number of persons in the imaging region to the control device 11.

In addition, the control device 11 performs an illumination control according to the presence or absence of a person, and the number of persons which are transmitted from the camera unit 15. In addition, the program for determining the number of persons may be included in the control device 11.

According to the embodiment, the control input value CI in FIG. 9 is the number of persons. Accordingly, a control output value CO is preset according to the number of persons as the control input value CI. For this reason, the change in an illumination range and illuminance of a gradation control region in which a center area CA is the center are predetermined according to the number of detected persons, and a corresponding relationship between the number of persons and the control input value CI is preset so as to become a control output value CO corresponding to the change. The corresponding relationship between the number of persons and the control input value CI are preset such that, for example, when the number of persons is one, the control input value CI is set to 10, when the number of persons is 5, the control input value CI is set to 50, and when the number of persons is 10 or more, the control input value is set to 100. Information on the corresponding relationship between the number of persons and the control input value CI is stored in the storage unit 11b.

### Operation

Subsequently, operations of the lighting control system 1A with the above described configuration will be described.

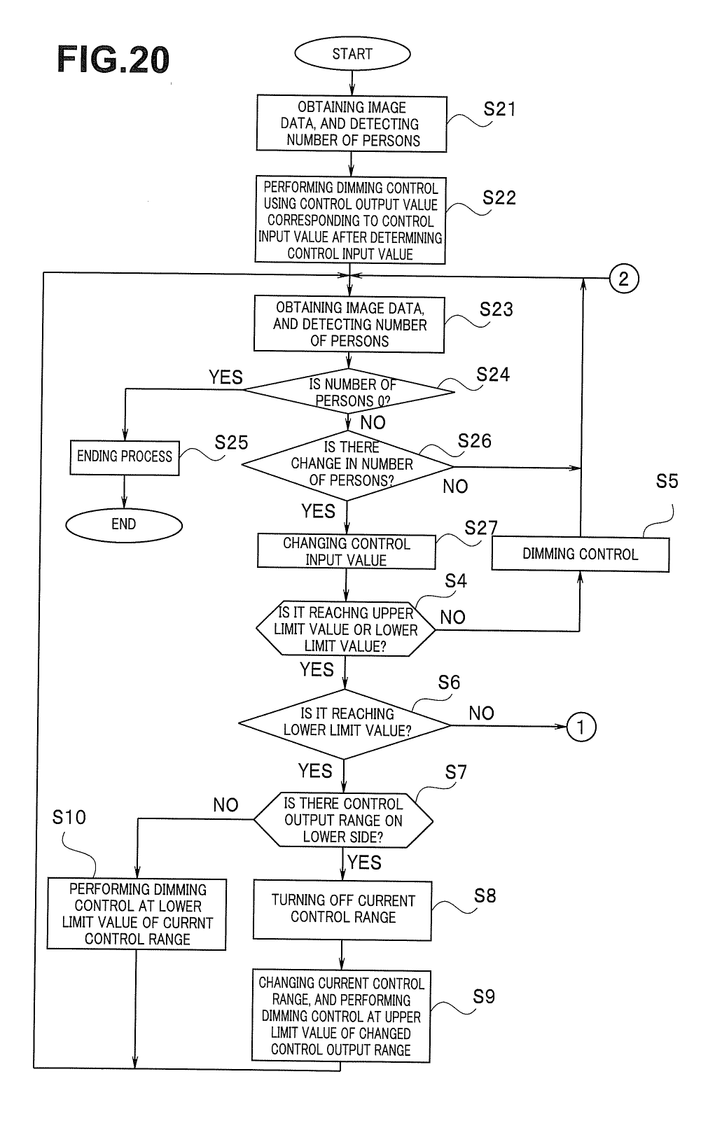

When a predetermined trigger occurs, for example, when pressing of the switch 13b of the wall switch 13 is detected, the control device 11 executes gradation controls in FIGS. 20 and 17. FIG. 20 is a flowchart which illustrates an example of a flow of gradation control mode processing. In FIG. 20, the same processing as that in FIG. 16 is given the same step number (S).

When the switch 13b is pressed, the CPU 11a obtains image data from the camera unit 15, first, and detects the number of persons in the gradation control region (S21). The detection of number of persons is performed by cutting out image data in the gradation control region from the image data, and by counting the number of persons in a range of the cut out image.

Subsequently, the CPU 11a determines the control input value CI based on the information on corresponding relationship between the number of persons and the control input value CI stored in the storage unit 11b, and performs a dimming control of the lighting fixture 12 using a control output value CO corresponding to the determined control input value CI (S22).

In addition, when the switch 13b is pressed, the CPU 11a may perform a dimming control of each lighting fixture 12 in the gradation control range using an initial value (for example, SP) of the control output value CO which is preset, first.

In addition, similarly to the first embodiment, the gradation control according to the embodiment may be also executed using a time schedule which is used in a clock included in the CPU 11a. In such a case, the switch 13 is not essential.

Subsequently, the CPU 11a obtains image data from the camera unit 15, detects the number of persons in the gradation control region (S23), and determines whether or not the detected number of persons is 0 (S24).

In addition, when the number of persons is 0, the CPU 11a executes a predetermined ending process for ending the gradation control (S25), and the process is ended.

In addition, when the number of persons is 0, the lighting fixture 12 may be subject to a dimming control using a value (for example, 5%) which is set as the lower limit value of the control output value CO without ending the gradation control.

When the number of persons is not 0 (NO in S24), the CPU 11a determines whether or not there is a change in the number of persons (S26). When there is no change in the number of persons (NO in S26), the process returns to S23, and when there is a change in the number of persons (YES in S26), the process moves to S27.

In S27, the control input value CI is changed according to the changed number of persons (S27). For example, when there is an increase of one person, the current control input value CI is increased by a predetermined amount d (for example, 10), and a process of changing the control input value CI is executed. In addition, when there is a decrease of two persons, the current control input value CI is decreased by a predetermined amount 2d (for example, 20) of twice, and a process of changing the control input value CI is executed.

After the process in S27, the process in S4 is executed, and after the process in S4, the same processes as those in FIGS. 17 and 18 are executed.

That is, in the lighting control system 1A according to the embodiment, the control input value CI is changed according to the number of persons in the gradation control region. Accordingly, the illumination range and illuminance in the gradation control region are automatically changed according to the number of persons.

In addition, in the above described example, the center area CA in the gradation control region is preset and fixed; however, the center area may be automatically set based on the image data which is obtained by the camera unit 15.

For example, the CPU 11a sets positions of the detected persons (in case of a plurality of persons, center position of each person's position in plane when viewing floor planarly) to the center area CA when a predetermined time (for example, 5 seconds) passes after pressing the switch 13b, and sets the peripheral areas PA1 and PA2 with respect to the center area CA.

In addition, the CPU 11a generates corresponding information between an ID of each lighting fixture which illuminates each area of the center area CA and the peripheral areas PA1 and PA2 and each area, as illustrated in FIG. 8, and stores the information in the storage unit 11b.

In this manner, it is possible to automatically set the center area of the gradation control according to the position of a person.

According to the embodiment, it is possible to obtain the same effect as that in the first embodiment, and to obtain an effect of automatically setting the illumination range and illuminance of the gradation control according to the detected number of persons.

As described above, according to the above described embodiments, it is possible to realize a lighting control system and a lighting control method in which the illumination range and illuminance of the gradation control can be changed so as to obtain an optimal range and illuminance for a person in the illumination range.

In addition, according to the above described embodiments, the number of peripheral areas is two; however, the number may be one, or three or more.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A lighting control system comprising:
a corresponding information setting unit in which information on a corresponding relationship between each of one region and a peripheral region of the one region and each of lighting fixtures which illuminates each of the on region and the peripheral region is set, in a gradation control region including the one region and the peripheral region; and
a control unit which performs a gradation control in which an illumination range and illuminance of the gradation control region are changed by performing a dimming control of each of the lighting fixtures so that, in brightness of the gradation control region, brightness of the one region and the peripheral region are changed while causing the one region to be brighter than the peripheral region in proportion to a control input value which is input to a control input unit.

2. The system according to claim 1,
wherein, when a control output value for controlling brightness in the one region reaches a set first upper limit value, the control unit performs a dimming control of each of the lighting fixtures so that brightness in the peripheral region is changed after a control output value for controlling the brightness in the peripheral region is set to a first lower limit value.

3. The system according to claim 1,
wherein, when the control output value for controlling brightness in the peripheral region reaches a set second lower limit value, the control unit performs a dimming control of each of the lighting fixtures so that brightness in the one region is changed after a control output value for controlling the brightness in the one region is set to a second upper limit value.

4. The system according to claim 1,
wherein a control output value for controlling brightness in the one region has a third lower limit value, and
the control unit does not set the control output value for controlling the brightness in the one region to be equal to or lower than the third lower limit value.

5. The system according to claim 1,
wherein a control output value for controlling brightness in the peripheral region has a third upper limit value, and
the control unit does not set the control output value for controlling the brightness in the peripheral region to be equal to or higher than the third upper limit value.

6. The system according to claim 1,
wherein the control input unit is an input unit which changes the control input value by moving a lever unit which is movable in a straight line direction, or by changing a bar graph display.

7. The system according to claim 1,
wherein the control input unit is an input unit which is rotatable about a predetermined axis, and changes the control input value according to a rotating amount.

8. The system according to claim 1,
wherein the control input value is a number of persons present in the gradation control region.

9. The system according to claim 1,
wherein the lighting control system includes a gradation control mode in which the gradation control is executed, and one other control mode than the gradation control mode, and
when moving to the gradation control mode from the other control mode based on a time schedule, the control unit performs a dimming control of each of the lighting fixtures so that a dimming state before moving is gradually changed to an initial state of the gradation control which is preset.

10. A lighting control system comprising:
a corresponding information setting unit in which information on a corresponding relationship between each of one region and a peripheral region of the one region and each of lighting fixtures which illuminates each of the one region and the peripheral region is set in a gradation control region including the one region and the peripheral region; and
a control unit which performs a gradation control in which an illumination range and illuminance of the gradation control region are changed by performing a dimming control of each of the lighting fixtures,
wherein the control unit performs a gradation control in which an illumination range and illuminance of the gradation control region is changed by performing a dimming control of each of the lighting fixtures so that, in brightness of the gradation control region, brightness of the one region and the peripheral region are changed while causing the one region to be brighter than the peripheral region in proportion to a control input value which is input to a control input unit,
when a control output value for controlling brightness in the one region reaches a set first upper limit value, the control unit performs a dimming control of each of the lighting fixtures so that brightness in the peripheral region is changed after a control output value for controlling the brightness in the peripheral region is set to a first lower limit value, and
when the control output value for controlling brightness in the peripheral region reaches a set second lower limit value, the control unit performs a dimming control of each of the lighting fixtures so that brightness in the one region is changed after a control output value for controlling brightness in the one region is set to a second upper limit value.

11. The system according to claim 10,
wherein the lighting control system includes a gradation control mode in which the gradation control is executed, and one other control mode than the gradation control mode, and
when moving to the gradation control mode from the other control mode based on a time schedule, the control unit performs a dimming control of each of the lighting fixtures so that a dimming state before moving is gradually changed to an initial state of the gradation control which is preset.

12. A lighting control method comprising:
setting information on a corresponding relationship between each of one region and a peripheral region of the one region and each of lighting fixtures which illuminates each of the one region and the peripheral region, in a gradation control region including the one region and the peripheral region; and
executing a gradation control in which an illumination range and illuminance of the gradation control region are changed by performing a dimming control of each of the lighting fixtures so that, in brightness of the gradation control region, brightnesses of the one region and the peripheral region are changed while causing the one region to be brighter than the peripheral region in proportion to a control input value which is input by a control input unit.

13. The method according to claim 12,
wherein, when a control output value for controlling brightness in the one region is set to a set first upper limit value, each of the lighting fixtures is subject to a dimming control so that brightness in the peripheral region is changed after a control output value for controlling brightness in the peripheral region is set to a first lower limit value.

14. The method according to claim 12,
wherein, when the control output value for controlling brightness in the peripheral region is set to a set second lower limit value, each of the lighting fixtures is subject to a dimming control so that brightness in the one region is changed after a control output value for controlling brightness in the one region is set to a second upper limit value.

15. The method according to claim 12,
wherein a control output value for controlling brightness in the one region includes a third lower limit value, and
the control output value for controlling the brightness in the one region is not set to be equal to or lower than the third lower limit value.

16. The method according to claim 12,
wherein a control output value for controlling brightness in the one region includes a third upper limit value, and
the control output value for controlling the brightness in the one region is not set to be equal to or higher than the third upper limit value.

17. The method according to claim 12,
wherein the control input unit is an input unit which changes the control input value by moving a lever unit which is movable in a straight line direction, or by changing a bar graph display.

18. The method according to claim 12,
wherein the control input unit is an input unit which is rotatable about a predetermined axis, and changes the control input value according to a rotating amount.

19. The method according to claim 12,
wherein the control input value is a number of persons present in the gradation control region.

20. The method according to claim 12, further comprising:
a gradation control mode in which the gradation control is executed, and one other control mode than the gradation control mode,
wherein, when moving to the gradation control mode from the other control mode based on a time schedule, the control unit performs a dimming control of each of the lighting fixtures so that a dimming state before moving is gradually changed to an initial state of the gradation control which is preset.
